(19) United States
(12) Patent Application Publication
(10) Pub. No.: US 2023/0380937 A1
(43) Pub. Date: Nov. 30, 2023

(54) ORTHODONTIC APPLIANCE WITH ALIGNER AND ATTACHMENT

(71) Applicant: 1092228 B.C. Ltd, Anmore (CA)

(72) Inventor: Zhi Chun Song, Anmore (CA)

(73) Assignee: 1092228 B.C. Ltd, Anmore, BC (CA)

(21) Appl. No.: 18/247,630

(22) PCT Filed: May 11, 2022
(86) PCT No.: PCT/IB2022/054395

§ 371 Date: Mar. 31, 2023

Related U.S. Application Data
(63) Continuation of application No. 17/323,886, filed on May 18, 2021, now abandoned.

(30) Foreign Application Priority Data
Jan. 31, 2022 (WO) PCT/CA2022/050135

(51) Int. Cl. A61C 7/08; A61C 7/36

(52) U.S. Cl. CPC A61C 7/08; A61C 7/36

(57) ABSTRACT

An orthodontic appliance for repositioning a tooth of a dental patient includes: (a) an attachment dimensioned for being attached to the tooth; and (b) an aligner having a cutout having an opening toward gingival side. The aligner and the attachment are dimensioned to engage with each other to inhibit the aligner displacement from its fully installed position. An aligner bulge over an unoccupied space feature next to the cutout may be applied in the orthodontic appliance to increase the flexibility of the aligner.

### TECHNICAL FIELD

This invention relates to orthodontic appliances and, in particular, to an orthodontic appliance involving the combined use of a dental aligner and a dental attachment.

### BACKGROUND ART

Dental aligners are used to straighten teeth as an alternative to dental braces. Aligners are typically formed as removable plastic trays that are customized to a patient's dental arch. The aligner provides a geometry selected to reposition the teeth from one tooth arrangement to the next arrangement. There are discrepancies between the aligner and the teeth, and the force generated by these discrepancies reposition the teeth to the next arrangement. However, a counterforce to the aligner may also lead to minor displacement of the aligner from its fully installed position in the dental arch.

A dental attachment is an object that is attached directly to the surface of a tooth of the patient. Dental attachments were introduced into dental treatment to improve the treatment result. The term “aligner system” refers to the combined use of one aligner and one or more dental attachments on the same dental arch of the patient. After more than 15 years of clinical use and improvement of aligner systems, there are still many problems in the treatment of difficult orthodontic cases.

Tooth tipping and minor dislocation of aligners often happen. The conventional aligner system, which consists of the aligner and the attachments, cannot prevent gradual unintentional dislocation of the aligner. Incomplete insertion may also result in aligner dislocation.

United States Patent application publication No. 2019/0274788 to cete et al. discloses orthodontic elastic attachments that are customized to fit with the cutout of the aligner with a gingival side opening. The base pad has a shape that complements the shape of the plastic window such that it fits within the aligner's cut-out like a puzzle piece. So, the base pad has contact with the cutout edge, but the aligner system of Celta et al. does not have features to prevent the aligner from dislocation, and no force engagement between the aligner and the attachment is mentioned.

United States Patent application publication No. 2004/0048223 to Phan et al. discloses an aligner system wherein the aligner slides over the attachments to fit into the designated place; and the aligner slides over the attachments again when the aligner is removed from the dental arch. This sliding over mechanism cannot prevent minor dislocation if the dislocation force is very big, and the retention force generated by the engagement between the attachment and the aligner is not big enough to hold the aligner in place. This aligner system of Phan et al. cannot prevent gradual displacement from the fully installed position.

Some improvement needs to be made to solve these problems.

### SUMMARY OF INVENTION

To prevent minor displacement of the aligner from its fully installed position on the dental arch and other problems with conventional aligner systems, the present invention provides novel orthodontic apparatus and methods of manufacturing.

One general aspect includes an orthodontic appliance for repositioning teeth. The orthodontic appliance also includes (a) an aligner having a thickness and may include a cutout located at a tooth surface of the teeth when the aligner is installed, and the cutout having an opening dimensioned for being oriented towards a gingival edge of the aligner; and (b) an attachment dimensioned for being attached to the tooth surface of the teeth where the cutout is aligned, the attachment having an attachment body and a base, the base being connected to the tooth surface, the attachment body projecting away from the tooth, where the height of the attachment body is longer than the thickness of the aligner at the cutout edge. The appliance also includes where a part of the aligner is at the gingival side of at least part of the attachment body and contacts the attachment body when the aligner is in its fully installed position, the side surface of the attachment body being dimensioned to inhibit the part of the aligner from sliding over the top surface of the attachment body when the aligner is being displaced from its fully installed position, the part of the aligner and the attachment body being dimensioned to resiliently engage with each other to hinder displacement of the aligner from its fully installed position.

Implementations may include one or more of the following features. The orthodontic appliance where the attachment may include a wing separated from the base, a slot being formed between the wing and one of the base and the tooth surface, the slot being formed between the wing and the tooth surface when the base does not extend laterally beyond the attachment body, the slot having an opening whose width is greater than the thickness of the aligner at the cutout edge. At least part of the side surface of the attachment body forms one of an acute and a right angle with the tooth surface. The height of the attachment body is at least 1.4 times the thickness of the aligner at the cutout edge. At least part of the aligner next to the cutout is spaced away from the tooth surface such that an unoccupied space feature is formed next to the cutout between the aligner and one of a) the attachment base and b) the tooth surface. An inner surface of the aligner is engaged with the attachment body when the aligner is fully installed. An outer surface of the aligner is engaged with the attachment body when the aligner is fully installed.

The teeth generally refer to all natural and non-natural teeth in a patient's dentition. The attachment is bonded to and/or formed over a dental feature in a desired location. The attachment may be bonded to any of these teeth with any suitable bonding material, typically dental restorative composites.

The attachments may be constructed from a variety of materials, including but not limited to metals, glass, porcelain or silicone filled polymers, and other composite materials. Such materials are typically designed to be chip, break and shear resistant for durability. The base of the attachment may be constructed from the same or from different materials as the attachment body. Likewise, the attachment body may be permanently or removably mounted on the base or the body and base may be constructed as one entity.

The attachment may also include or function as a hook for traction in some situations. This attachment can be used in the intramaxillary traction or intermaxillary traction.

One general aspect includes a method of manufacturing an aligner for repositioning teeth having at least one cutout which has an opening toward a gingival edge of the aligner when the aligner is fully installed. The method also includes (a) providing a positive model of a dentition having model teeth and model gingiva next to the model teeth, and providing at least one added structure on a tooth surface of the model; (b) forming the aligner over the positive model and over the added structure such that the aligner includes a protrusion at the added structure location, and (c) cutting across the protrusion to form the cutout having a cutout edge raised away from a tooth surface of the teeth when the aligner is fully installed.

Implementations may include one or more of the following features. The method where the added structure extends to a gingival side of the model of the dentition, so that the cutout has an opening toward the gingival edge of the aligner when the aligner is fully installed. The protrusion may include at least one sidewall extending at an angle of more than 60 degrees relative to a part of the teeth surface of the model under the protrusion when the aligner is seated on the model. The protrusion has a base which extends laterally beyond a distal part above the base, and where the step of cutting is across the distal part. The method may include cementing an attachment to the teeth and installing the aligner onto the teeth by resiliently engaging the attachment into the cutout.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF DRAWINGS

In drawings which illustrate by way of example only embodiments of the invention:

FIG. 1 is a perspective view of the orthodontic appliance according to a first embodiment of the invention, showing an aligner having a cutout and an attachment attached to a tooth of a patient;

FIG. 2 is a close-up perspective view of a portion of the orthodontic appliance shown in FIG. 1;

FIG. 3 is a close-up perspective view of the portion shown in FIG. 2, showing initial contact between the aligner and attachment;

FIG. 4 is a close-up perspective view of the portion shown in FIGS. 2 and 3, showing the aligner fully installed and engaging the attachment;

FIG. 5 is a top view of the attachment of FIG. 4 and the cutout of the aligner when it is fully installed, showing contact between the attachment and a projection of the aligner;

FIG. 6 is a top view of the attachment and the cutout of the aligner shown in FIG. 5, showing the attachment in a second, different position;

FIG. 7 is a top view of the attachment and the cutout of the aligner shown in FIGS. 5 and 6, showing the attachment in a third position;

FIG. 8 is a top view of the cutout of the aligner shown in FIGS. 5 to 7, showing an alternative attachment having a different position and size;

FIG. 9 is a top view of the cutout of the aligner shown in FIGS. 5 to 8, showing a third attachment having an elliptical shape;

FIG. 10 is a top view of the cutout of the aligner shown in FIGS. 5 to 9, showing a fourth attachment having a triangular shape and showing, by dotted line, the aligner displaced from its fully installed position;

FIG. 11 is a top view of the cutout of the aligner shown in FIGS. 5 to 10, showing the cutout and attachment having complementary shapes;

FIG. 12 is a side sectional view of the portion of the appliance shown in FIGS. 4 and 5, showing an attachment body of the attachment contacting a first portion of the aligner projection and not showing other portions of the aligner;

FIG. 13 is a side sectional view of the portion shown in FIG. 12, showing a variation of the attachment having a short attachment body;

FIG. 14 is a side sectional view of the portion shown in FIGS. 12 and 13, showing a varied attachment body whose side surface forms an acute angle with a tooth surface;

FIG. 15 is a side sectional view of the portion shown in FIGS. 12 to 14, showing a varied attachment body whose side surface forms an obtuse angle with the tooth surface;

FIG. 16 is a side sectional view of the portion shown in FIGS. 12 to 15, showing the attachment having a base that extends laterally beyond the attachment body;

FIG. 17 is a side sectional view of the portion shown in FIG. 16, showing the attachment having a beveled base;

FIG. 18 is a side sectional view of the portion shown in FIGS. 16 and 17, showing the attachment and its base having smoothly rounded edges;

FIG. 19 is a perspective view of a variation of the attachment shown in FIGS. 1 to 18, showing the attachment having a wing;

FIG. 20 is a perspective view of a further variation of the attachment shown in FIG. 19, showing an elliptical wing;

FIG. 21 is a side sectional view of the portion shown in FIGS. 12 to 18, showing the variation of the attachment having a wing;

FIG. 22 is a side sectional view of the portion shown in FIG. 21, showing a variation of the attachment having the wing and the beveled base;

FIG. 23 is a side sectional view of the portion shown in FIGS. 21 and 22, showing a variation of the attachment having a single-sided wing;

FIG. 24 is a side sectional view of the portion shown in FIG. 23, showing a variation of the attachment having a slot of inwardly decreasing width;

FIG. 25 is a close-up perspective view of a portion of the appliance according to a second embodiment of the invention, showing a cutout having a pair of opposing projections and the attachment having a circular base and a circular wing;

FIG. 26 is a perspective view of the portion shown in FIG. 25, showing initial contact between the aligner and the attachment;

FIG. 27 is a perspective view of the portion shown in FIGS. 25 and 26, showing the aligner fully installed and engaging the attachment;

FIG. 28 is a top view of the cutout of the aligner and the attachment of FIG. 27, shown for clarity without the base and the wing, showing the aligner in its fully installed position;

FIG. 29 is a top view of the cutout of the aligner shown in FIG. 28, showing a variation of the attachment body having a parallelogram-shaped cross-section;

FIG. 30 is a top view of the cutout of the aligner shown in FIGS. 28 and 29, showing a further variation of the attachment body having a bullet-shaped cross-section;

FIG. 31 is a top view of a variation of the portion of the appliance shown in FIGS. 28 to 30, showing a diamond-shaped cutout;

FIG. 32 is a top view of a portion of the appliance according to a third embodiment of the invention, showing a secondary cutout and a window dimensioned to not engage with any attachment;

FIG. 33 is a top view of a variation of the portion of the appliance shown in FIGS. 28 to 30 according to a fourth embodiment of the invention, showing no gingival projection;

FIG. 34 is a top view of the portion shown in FIG. 33, showing the attachment body in a second, different position;

FIG. 35 is a top view of the portion shown in FIG. 33, showing the attachment body in a third, different position;

FIG. 36 is a top view of a portion of the appliance according to a fifth embodiment of the invention, showing a pair of opposing projections in contact with each other at their respective projection tips;

FIG. 37 is a top view of a portion of the appliance according to a sixth embodiment of the invention, showing the projection tip contacting the aligner at the opposite side of the opening;

FIG. 38 is a sectional view of a portion of a dental arch with an aligner fully installed according to a seventh embodiment of the invention, showing an aligner bulge next to a cutout engaged with an attachment body;

FIG. 39 is a side sectional view of the portion shown in FIG. 12 to 18, showing a variation having an inner surface of a part of an aligner engaged with an attachment body when the aligner is fully installed;

FIG. 40 is a side sectional view of the portion shown in FIG. 39, showing a variation having an aligner bulge arranged next to the attachment when the aligner is fully installed;

FIG. 41 is a side sectional view of the portion shown in FIG. 40, showing a variation having an outer surface of a part of an aligner engaged with an attachment body when the aligner is fully installed;

FIG. 42 is a side sectional view of an aligner protrusion formed over an added structure on a tooth surface of a model of a dentition, showing manufacturing using an added structure and an aligner protrusion;

FIG. 43 is a side sectional view of the aligner protrusion shown in FIG. 42 when the aligner is fully installed on the tooth of the model of the dentition without the added structure, showing the aligner protrusion and a cross section lines I-I;

FIG. 44 is a side sectional view of the aligner protrusion shown in FIG. 43, showing a cutout formed at the cross-section lines Hof the aligner protrusion on a tooth surface of a patient;

FIG. 45 is a side sectional view of an attachment cemented in the cutout shown in FIG. 44 and engaging with the aligner;

FIG. 46 is a side sectional view of another aligner protrusion when the aligner is fully installed on the model of the dentition, showing the aligner protrusion and a cross-section lines H-H;

FIG. 47 is a side sectional view of the aligner protrusion shown in FIG. 46 with a cutout formed at the cross-section lines H-H of the aligner protrusion;

FIG. 48 is a side sectional view of another aligner protrusion formed over an added structure on a tooth surface of a model of a dentition, showing manufacturing using an added structure and an aligner protrusion;

FIG. 49 is a side sectional view of the aligner protrusion shown in FIG. 48 when the aligner is fully installed on the tooth of the model of the dentition without the added structure, showing the aligner protrusion and a cross section lines E-E;

FIG. 50 is a top view of the aligner protrusion shown in FIG. 49, showing the cross-section E-E and the cut out of the aligner and an aligner gingival edge;

FIG. 51 is a side sectional view of the aligner protrusion shown in FIG. 49, showing a cutout formed at the cross-section E-E of the aligner protrusion on a tooth surface of a patient;

FIG. 52 is a side sectional view of an attachment cemented in the cutout shown in FIG. 51 and engaging with the aligner; and

FIG. 53 is a top view of the aligner cutout and attachment shown in FIG. 52.

### DESCRIPTION OF EMBODIMENTS

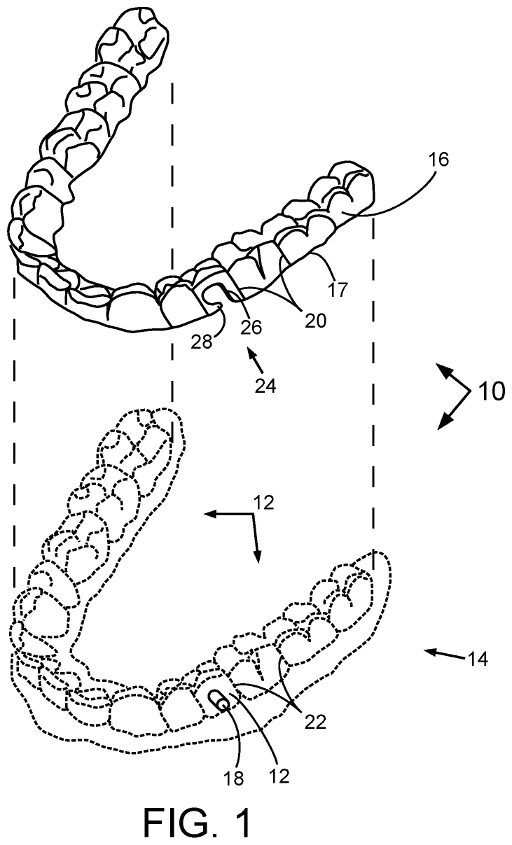

Referring to FIG. 1, the orthodontic appliance is an apparatus according to a first embodiment of the invention that is shown generally at the appliance 10. The appliance 10 functions to reposition one or more teeth 12 of a dental arch 14 of a dental patient. In FIG. 1, the dental arch 14 and its teeth 12 are shown by dotted line. The appliance 10 involves the combination of an aligner 16 and an attachment 18 dimensioned for being attached, such as by adhesive bonding, to a given tooth 12, the aligner 16 having cavities dimensioned to receive the teeth. A repositionable tooth refers to a tooth which is arranged to be repositioned to correct alignment and spacing.

While FIG. 1 shows one attachment 18 attached to one tooth 12, in general any number of attachments 18 attached to any number of teeth 12 of an upper and/or lower dental arch 14 may be employed to achieve a desired dental result.

Referring to FIGS. 1 to 4, the aligner 16 has a thickness and comprises a cutout 24 for being located at a tooth surface of a tooth when the aligner is fully installed 34, which cutout 24 has an opening at a gingival edge 17 of the aligner 16. The aligner 16 may comprise more than one cutout 24, and each one of the cutouts 24 may have an associated attachment 18. The aligner 16 next to the one cutout 24 and the associated attachment 18 are dimensioned to engage with each other to hinder displacement of the aligner 16 from its fully installed position 34. The attachment 18 is dimensioned for being attached to the tooth surface where the cutout 24 is aligned. The attachment 18 has an attachment body 44 and a base, the base is connected to the tooth surface, the attachment body 44 projects away from the tooth 12. The height of the attachment body 44 is greater than the thickness of the aligner 16 at a cutout edge 26 of the cutout 24. In FIG. 1, the cutout and the attachment are arranged on a buccal surface of a tooth. The cutout 24 and the attachment 18 may also be arranged on a lingual surface of a tooth 12.

Referring to FIGS. 1 to 4, the aligner 16 is typically made of a resilient material custom-fitted to the shapes of the teeth 12 of the dental arch 14. The aligner 16 typically includes inward facing ridges 20 associated with the natural indentations 22 between adjacent pairs of teeth 12. A given ridge 20 typically is selected to conform to its associated indentation 22 for a natural fit of the aligner 16 to the dental arch 14 resulting in the insertion route 32 of the aligner being determined. The insertion and removal of the aligner 16 typically follows the same route 32. Formed within the aligner 16 is a cutout 24 that defines a cutout edge 26. In the embodiments of FIGS. 1 to 4, the cutout 24 has an opening at a gingival edge 17 of the aligner 16 to permit removable installation of the aligner 16 onto the dental arch 14 of the patient, the cutout 24 is at the buccal surface of a tooth and has an opening toward gingiva when the aligner 16 is in its fully installed position 34. The cutout 24 and the attachment 18 also can be arranged at the lingual surface of a tooth in some situations.

The aligner 16 along its cutout edge 26 defines a projection 28 that projects inwardly into the cutout 24. Because the insertion and removal of the aligner 16 follows the insertion route 32, the projection 28 of the aligner 16 also typically follows the insertion route 32 during insertion or removal of the aligner 16. The projection 28 is dimensioned to resiliently engage the attachment 18 during installation of the aligner 16 (FIGS. 3 and 4) such that the projection 28 hinders dislocation of the aligner 16 after the aligner 16 has been installed. In the exemplary embodiments of FIGS. 1 to 4, the projection 28 has a smoothly rounded tip 30 for ease of installation of the aligner 16.

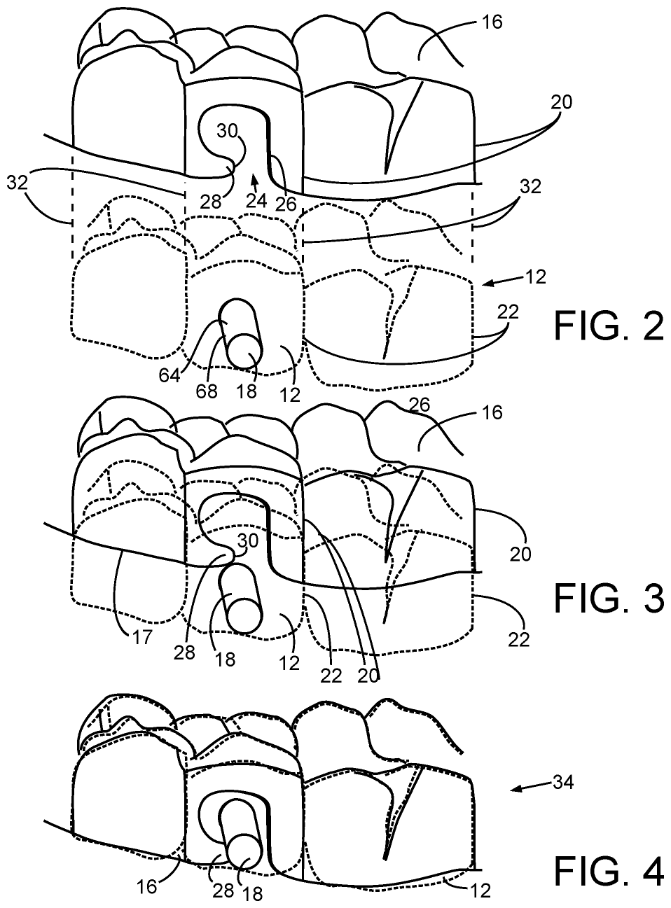

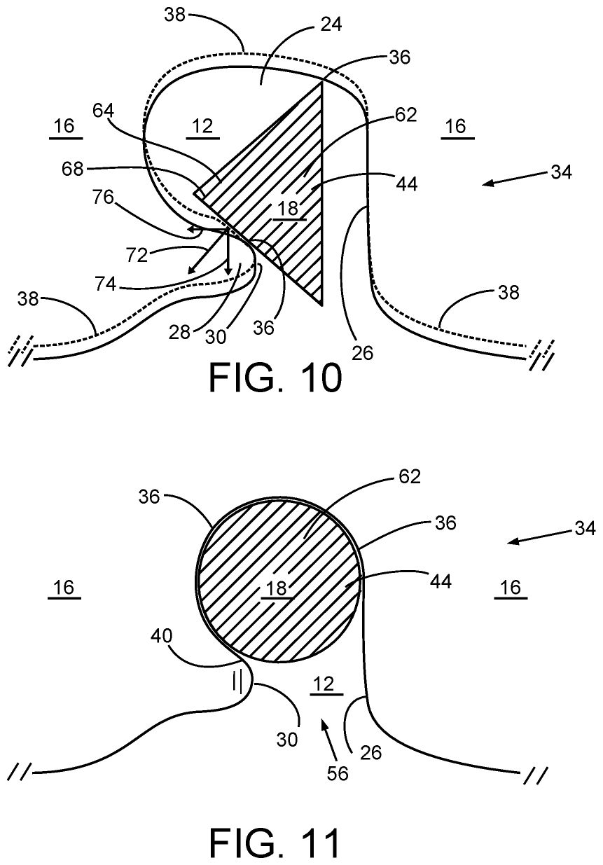

Referring to FIGS. 2, 3 and 4, the projection 28 contacts the attachment 18 when it follows the insertion route 32 to insert the aligner 16 into the fully installed position 34. The projection 28 is squeezed by the attachment 18 during the aligner insertion. The attachment 18 directs a compressive force on the projection 28 during installation of the aligner 16. From a point of initial contact (FIG. 3), such compressive force increases as the aligner 16 is moved toward its fully installed position 34 (FIG. 4). Midway between initial contact and the fully installed position 34, a point of maximum compressive force is reached. Thereafter, the compressive force becomes reduced and has a vertical component force toward the gingiva side (FIG. 10) as the aligner 16 is moved into its fully installed position 34. Thus, the resilient engagement of the projection 28 against the attachment 18 advantageously prevents incomplete installation of the aligner 16 by urging the aligner 16 toward its fully installed position 34 after having reached its midway point of maximum compressive force.

As indicated in FIGS. 3 and 4, the aligner 16 is typically transparent or clear such that the teeth 12 are visible beneath the aligner 16. In variations, the projection 28 can project inwardly toward the interior of the cutout 24 from anywhere along the cutout edge 26, and in general any number of projections 28 may be employed. Usually, a cutout 24 is located on the buccal and/or the lingual surface of the teeth when the aligner is installed, and the cutout 24 has an opening dimensioned for being oriented towards the gingiva. The projection 28 of the aligner 16 projects from the mesial side and/or the distal side of the cutout 24 toward the interior of the cutout 24.

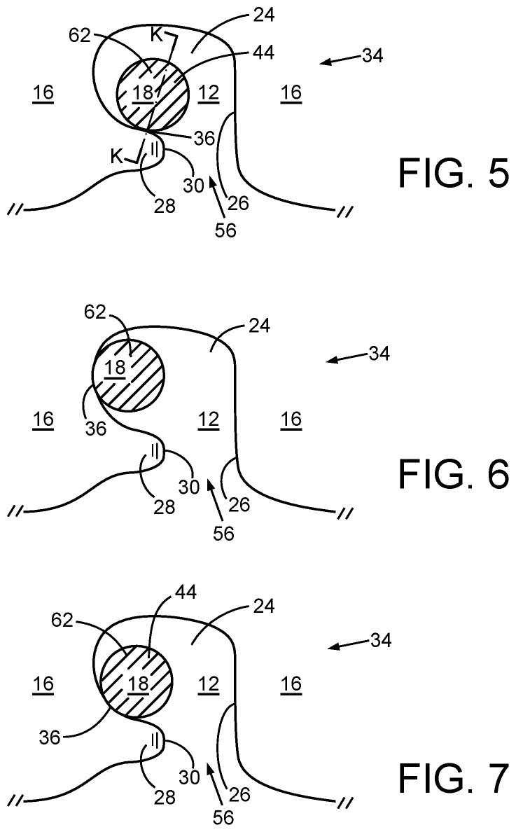

Referring to FIG. 5 in top view, the aligner 16 in its fully installed position 34 places the projection 28 in contact with the attachment 18. A part of the aligner 16 is at the gingival side of the attachment body 44 and contacts the attachment body 44 when the aligner 16 is in its fully installed position 34. The cutout edge 26 is resiliently engaged with the attachment body 44 to hinder displacement of the aligner 16 from its fully installed position 34. A passage 56 of the cutout is opening toward the gingival side. A side sectional view is made along lines K-K which passes through the contact point 36 between the part of the aligner 16 and the attachment body 44.

Referring to FIGS. 2 to 5, in the embodiment a situation analogous to insertion happens during dislocation of the aligner 16 because the removal also follows the same route 32. The projection 28 contacts the attachment 18 at the contact point 36 when the aligner is in its fully installed position 34, such that the attachment 18 may deliver a retention force to the aligner 16 through the projection 28. In most cases the dental arch 14 may also deliver a dislocation force to the aligner 16. If there is a dislocation force on the aligner 16, the projection 28 and the attachment 18 are dimensioned and positioned to resiliently engage with each other to counteract the dislocation force to maintain the aligner 16 in the fully installed position 34.

Referring to FIGS. 5 to 7, the attachment 18 may in general contact the cutout edge 26 at any contact point 36 thereof when the aligner 16 (a portion only of which is seen in FIGS. 5 to 7) is in its fully installed position 34. Such fully installed position 34 of the aligner 16 provides in some embodiments a persistent force by the aligner 16 at the contact point 36 to the given tooth 12 via the attachment 18. Such persistent force persists for the duration of time that the aligner 16 remains in its installed position, and typically acts to reposition the given tooth 12 in a desired direction. The attachment 18 need only contact a portion of the cutout edge 26 when the aligner 16 is in its fully installed position 34 for such persistent force to act as a repositioning force.

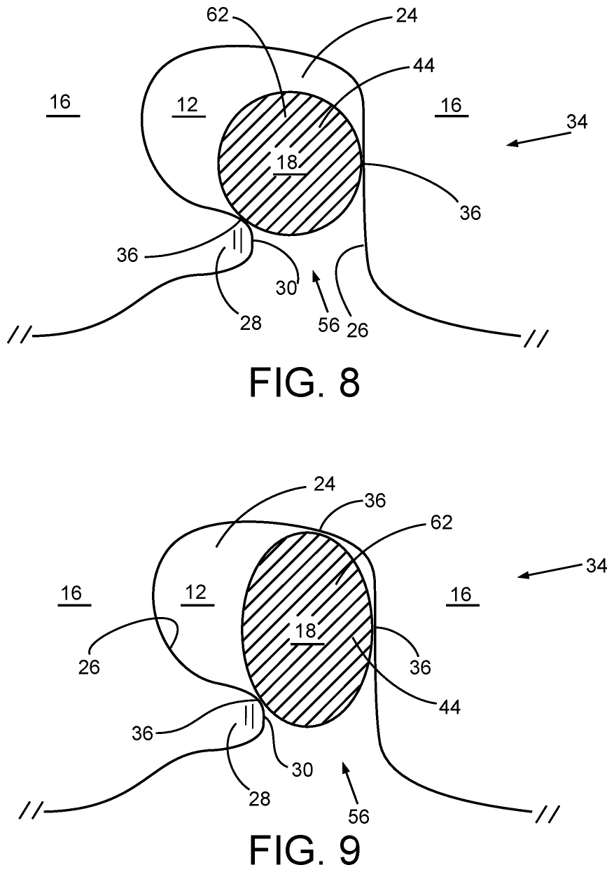

Referring to FIGS. 8 to 10, the attachment 18 may have any desired shape and size to produce the persistent repositioning force in any desired direction at any number of different contact points 36 along the cutout edge 26. In some embodiments, the aligner 16 in its fully installed position 34 extends partly over the gingiva of the patient.

Referring to FIG. 10, the attachment body 44 has a protrusion 64 which projects in the opposite direction of the projection 28, and the attachment body protrusion 64 has a protrusion tip 68. During insertion of the aligner 16 the attachment body 44 deliver a compressive force on the projection 28. From a point of initial contact (FIG. 3), such compressive force increases as the aligner is moved toward its fully installed position 34 (FIG. 4). The projection 28 reaches the biggest deformation at the point of contact between the projection tip and the protrusion tip 68, and at this point the attachment body 44 delivers maximum compressive force to the projection 28. Thereafter, the compressive force 72 becomes reduced and has a vertical component force 74 toward the gingiva as the aligner 16 is moving into its fully installed position 34. Thus, the resilient engagement of the projection 28 against the attachment body 44 advantageously prevents incomplete installation of the aligner 16 by urging the aligner 16 toward its fully installed position 34 after having reached its midway point of maximum compressive force.

The minor displacement of the aligner 16 from its fully installed position 34 to a displaced position 38 causes compression of the resilient material of the projection 28, thereby urging the aligner 16 to return toward its fully installed position 34; the attachment body 44 delivers a compressive force 72 to the projection 28, and this compressive force 72 defines not only a horizontal component force 76, but also a vertical component force 74 that directs toward the gingiva and guides the aligner 16 to return to its fully installed position 34.

Referring to FIG. 11 in top view, the attachment body 44 has a shape and size that is harmonious (i.e. coincides) with the cutout 24, and the attachment body 44 has contact with most of the inner edge 40 of the cutout at the fully installed position 34, displacement of the aligner 16 may trigger compressive force 72 (FIG. 10) which may urge the aligner 16 toward its fully installed position 34.

Referring to FIGS. 5 to 11, the projection 28 and the attachment 18 are dimensioned to resiliently engage with each other to hinder displacement of the aligner 16 from its fully installed position 34, the tip 30 of the projection 28 of the aligner 16 is at the gingival side of at least part of the attachment body 44 when the aligner 16 is in its fully installed position 34 and the projection 28 contacts the attachment body 44. The projection tip 30 is smoothly rounded. In these embodiments the attachment body 44 contacts only a portion of the cutout edge 26 when the aligner 16 is inserted into the fully installed position 34. The cutout edge 26 is resiliently engaged with the attachment body 44 to hinder displacement of the aligner 16 from its fully installed position 34. A passage 56 of the cutout is opening toward the gingival side. All these features shown in these figures may be applied in any embodiment about the cutout and attachment and combined with other features of the embodiment.

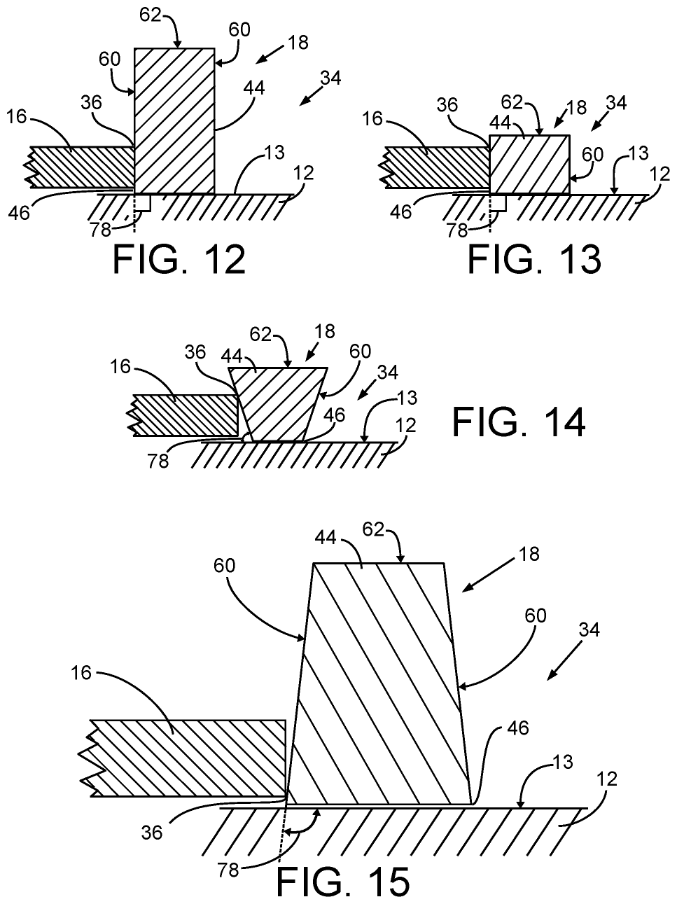

FIG. 12 is a side view along lines K-K of FIG. 5, FIGS. 13 to 18 are variations of the embodiment showed in FIG. 12, these Figures only show the side view of a portion of the aligner 16 and the attachment 18 and for ease of illustration do not show the other parts of aligner 16. This portion of the aligner 16 is at the gingival side of the attachment body 44 and contacts the attachment body 44 at a contact point 36 when the aligner is in its fully installed position 34 (referring to FIG. 5). The attachment 18 includes its attachment body 44 projecting vertically away from its base 46 that is adjacent to the tooth surface 13. In the exemplary embodiments of FIGS. 12 and 13, the base 46 has the same width as the attachment body 44. In the exemplary embodiments of FIGS. 12 to 15, the aligner 16 in its fully installed position 34 contacts the attachment body 44 at the contact point 36. Usually, the projection 28 of the aligner 16 has more than one contact point 36 with the attachment body 44.

Referring to FIGS. 12 and 13, the side surface 60 of attachment body 44 forms an angle 78 with the tooth surface 13 that is a right angle 78.

Referring to FIG. 13, the attachment body 44 in its direction of projection may have any suitable length. Typically, the height of the attachment body 44 is greater than the thickness of the aligner 16 at the cutout edge to inhibit the projection 28 (referring to FIGS. 5 to 11) from sliding on the top surface 62 of the attachment body 44 and potentially displacing the aligner 16. Referring to FIGS. 12 to 18, the attachment body 44 in some embodiments is at least 1.4 times as long as the thickness of the aligner 16 at the cutout edge 26.

Referring to FIG. 14, the side surface 60 of the attachment body 44 forms the angle 78 with the tooth surface 13 which in this embodiment is an acute angle 78. In this embodiment the height of the attachment body 44 is greater than the thickness of the aligner 16. In this embodiment the attachment body 44 inhibits the projection 28 from sliding on the top surface 62 of the attachment body 44 when the aligner 16 is displaced from its fully installed position 34.

Referring to FIG. 15, the side surface 60 of the attachment body 44 forms the angle 78 with the tooth surface 13 which in this embodiment is an obtuse angle 78, this angle is smaller than 130 degrees. In this embodiment the length of the attachment body 44 is typically made sufficient to prevent the projection 28 (FIG. 6 et al.) sliding on the top surface 62 of the attachment body 44. The attachment body 44 in some embodiments is at least 1.8 times as long as the thickness of the aligner 16 at the cutout edge 26.

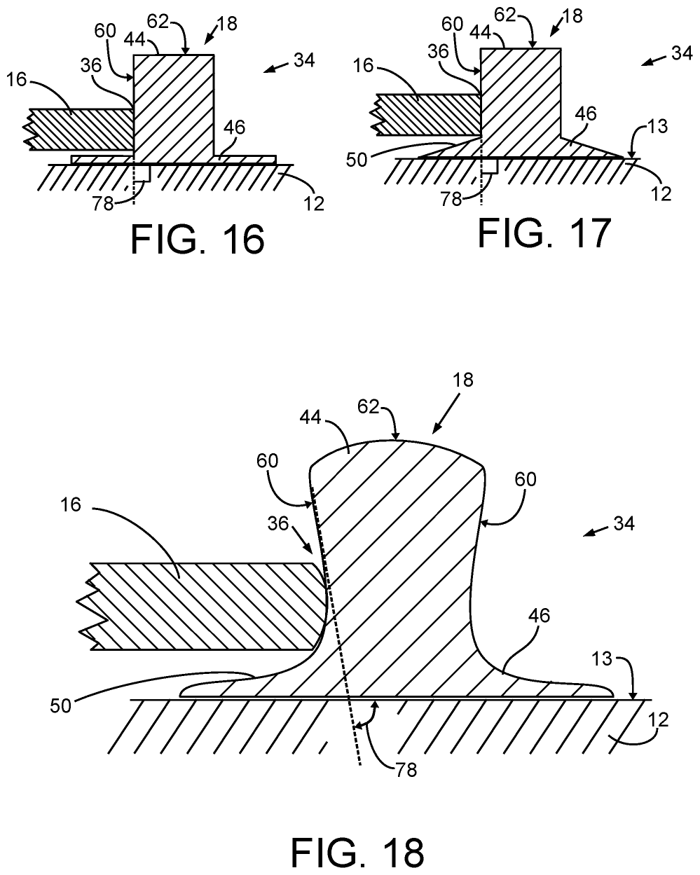

Referring to FIGS. 16 to 18, the base 46 in some embodiments extends from the attachment body 44 adjacently to the given tooth surface 13 to advantageously define a larger surface area for attaching the attachment 18 to the given tooth 12. In variations, the base 46 can be attached to the attachment body 44 in any suitable manner, including being integrally attached as shown in FIGS. 16 to 18. In contrast to the embodiments of FIGS. 12 to 15, the exemplary embodiments of FIGS. 16 to 18 show the surface area of the base 46 being greater than the cross-sectional area of the attachment body 44.

The base 46 may have any suitable shape, including circular, elliptical, polygonal, or irregular for example. The base 46 in some embodiments is beveled, such as by being sloped downwardly as viewed in FIG. 17 or having a smoothly rounded bevel 50 as shown in FIG. 18 for example.

The base 46 and the attachment body 44 in some embodiments have orthogonal surfaces, as shown in FIG. 16 for example. Additionally, or alternatively, the base 46 and/or the attachment body 44 may have smoothly rounded edges, as shown in FIG. 18 for example. In the exemplary embodiment shown in FIG. 18, the attachment body 44 widens in the direction projecting away from the given tooth 12, thereby assisting in preventing the aligner 16 from sliding on a top surface 62 of the attachment body 44.

Referring to FIG. 18, part of the side surface 60 of the attachment body 44 forms the angle 78 with the tooth surface 13 which in this embodiment is an acute angle 78. The attachment body 44 is longer than the thickness of the aligner 16 at the cutout edge, and such embodiment can prevent the aligner 16 from sliding on the top surface 62 of the attachment body 44.

Referring to FIGS. 5 to 11, one projection 28 extends toward the interior of the cutout 24. More than one projection may be provided in other embodiments. A part of the projection 28 is at the gingival side of the attachment body 44 and contacts the attachment body 44 at the contact point 36 when the aligner 16 is in its fully installed position 34; referring to FIGS. 12 to 18, a height of the attachment body 44 is greater than the thickness of the aligner 16 at a cutout edge 26 of the cutout 24. The height of the attachment body 44 may be at least 1.4 times the thickness of the aligner 16 at the cutout edge 26 in some cases, and may be at least 1.8 times the thickness of the aligner 16 in a few cases. The side surface 60 of the attachment body 44 is dimensioned to inhibit the aligner 16 from sliding on the top surface 62 of the attachment body 44. This functions during an insertion and a dislocation of the aligner, and functions when the aligner is fully installed 34. The part of the projection 28 and the attachment body 44 is dimensioned to resiliently engage with each other to hinder displacement of the aligner from its fully installed position 34. All the features shown in these figures may be applied in any embodiment of the cut out and attachment and combined with other features of the embodiment.

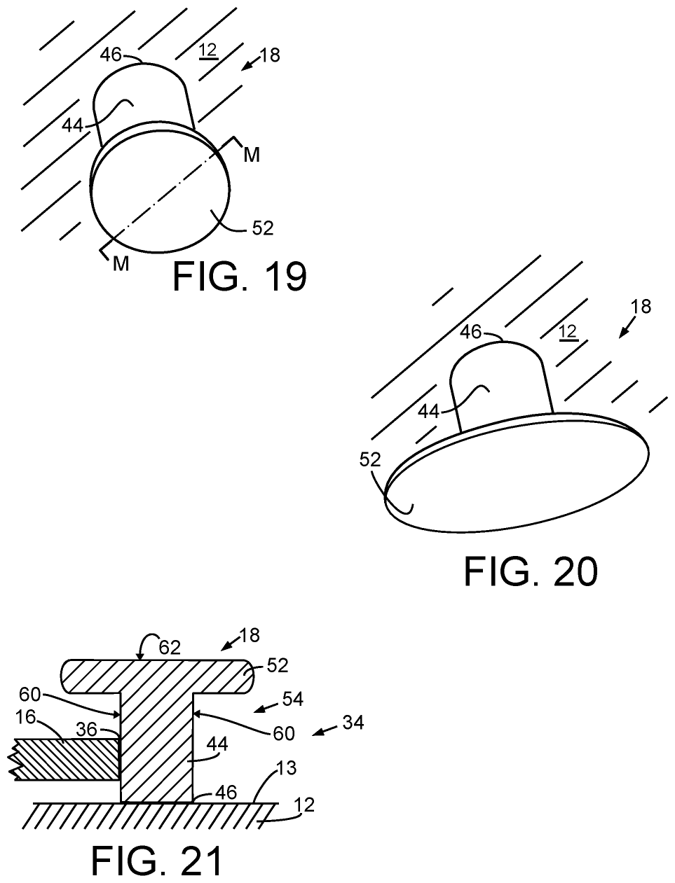

Referring to FIG. 19, the attachment 18 in some embodiments includes a wing 52 that extends radially away from the attachment body 44 distal from the base 46. The wing 52 typically extends wider than the attachment body 44. The wing 52 in some embodiments is elliptical as shown in FIG. 20. Other shapes of the wing 52 are possible, and in general the wing 52 may have any suitable shape. In some embodiments (not shown), the attachment 18 including any wing 52 is dimensioned to act as a hook, e.g. for dental traction component(s).

Referring to FIG. 21 providing a side view along lines M-M of FIG. 19, the attachment 18 defines a slot 54 between the wing 52 and the tooth surface 13. The slot 54 is dimensioned to constrain the aligner 16 and its cutout edge 26 between the tooth surface 13 and the wing 52 to prevent the projection 28 (Figure et al.) from sliding onto a top surface 62 of the attachment body 44. The slot 54 width is equal to the distance between the wing 52 and the tooth surface 13 (or the base when the attachment has an enlarged base 46). The width of the slot 54 is bigger than the thickness of the portions of the cutout edge 26 that pass within the slot 54.

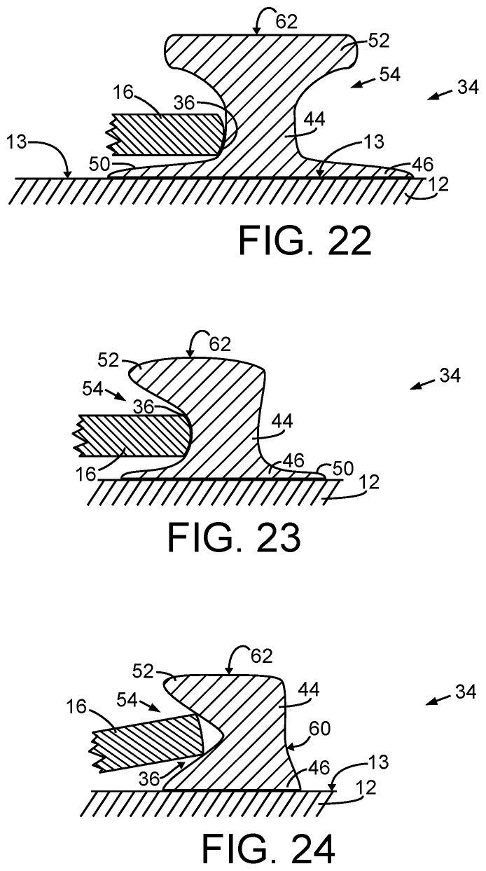

Referring to FIG. 22, the base 46 in some embodiments has a bevel 50 to provide a sloped guide of the aligner 16 into the slot 54. The slot 54 in general may have any suitable shape, including being smoothly rounded at its edges for example. In this embodiment the slot 54 width is equal to the distance between the wing 52 and the base 46, and the width of the slot 54 is bigger than the thickness of the portions of the cutout edge 26 that pass within the slot 54.

Referring to FIG. 23, the wing 52 typically extends beyond the width of the attachment body 44 at the contact point(s) 36 and does not necessarily (although it may) extend beyond the width of the attachment body 44 elsewhere. In some embodiments, the wing 52 and the slot 54 are one-sided as shown in FIG. 23.

Referring to FIG. 24, the slot 54 has an opening toward the aligner 16 and the opening is greater than the thickness of the aligner 16 at the cutout edge. In this embodiment, the opening of the slot 54 is greater than the thickness of the aligner 16 and some other parts of the slot 54 is not as great as the thickness of the aligner 16 at the cutout edge.

Referring to FIGS. 21 to 24, the slot 54 at its opening has a width that is greater than the thickness of the aligner 16 at the cutout edge. This embodiment can keep the aligner 16 sliding in the slot 54 without sliding on the top surface 62 of the attachment body 44. All the features shown in these figures may be applied in any embodiment about the cutout and attachment and combined with other features.

Referring to FIGS. 12 to 24, a height of the attachment body 44 is greater than the thickness of the aligner 16 at a cutout edge 26 of the cutout 24. In some cases the height of the attachment body 44 is at least 1.4 times the thickness of the aligner 16 at the cutout edge 26, in a few cases at least 1.8 times the thickness of the aligner 16 at the cutout edge 26; A part of the aligner 16 is at the gingival side of the attachment body 44 and contacts the attachment body 44 at the contact point 36 when the aligner is in its fully installed position 34 (referring to FIG. 5). In these Figures, the contact points 36 are at the gingival side of the attachment bodies 44, but the same dimensions and arrangements of the attachment bodies 44 and the aligners 16 may be applied to other contact points which are not at the gingival side of the attachment bodies 44. The side surface of the attachment body 44 is dimensioned to inhibit the aligner 16 from sliding on the top surface 62 of the attachment body 44, this may function during an insertion or a dislocation of the aligner, and may function when the aligner is fully installed 34; the part of the aligner 16 and the attachment body 44 being dimensioned to resiliently engage with each other to hinder displacement of the aligner 16 from its fully installed position 34; In most cases at least part of the side surface 60 of the attachment body 44 forms one of an acute and a right angle with the tooth surface, In a few cases at least part of the side surface 60 of the attachment body 44 may form an angle with the tooth surface less than 130 degrees; The attachment 18 may comprise a wing 52 separated from the base 46, the wing 52 being dimensioned to prevent the aligner 16 from sliding on a top surface 62 of the attachment body 44. All the features shown in the figures may be applied in any embodiment having the innovative cutout and attachment. By applying the features shown in these figures, a side surface 60 of an attachment body 44 may be dimensioned to inhibit a part of an aligner 16 next to the cutout when the aligner is fully installed 34 from sliding on a top surface 62 of the attachment body.

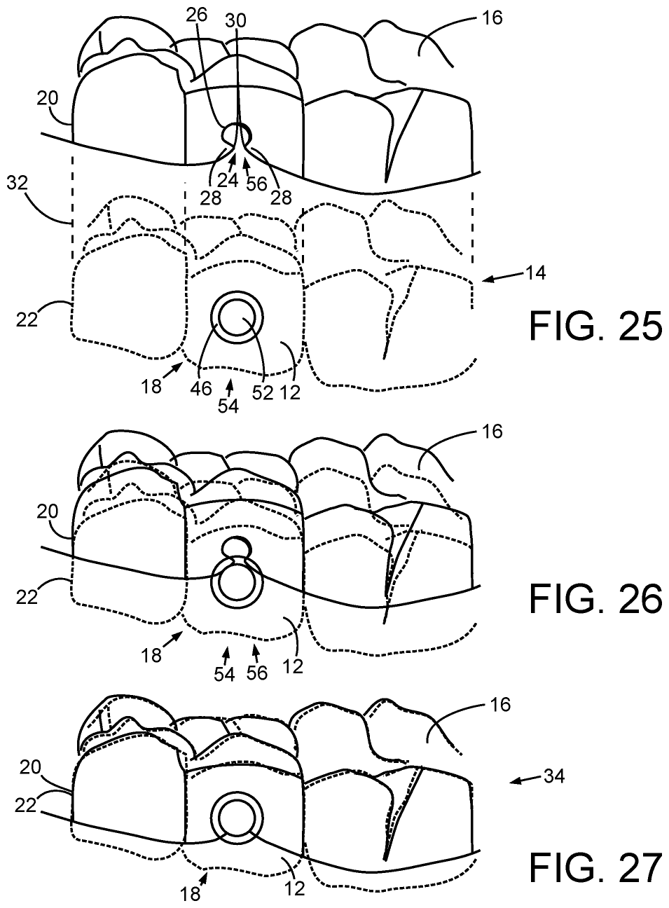

Referring to FIGS. 25 to 27, the cutout edge 26 of the aligner 16 in some embodiments defines more than one projection 28. In the exemplary embodiment of FIG. 25, the aligner 16 includes one cutout 24 whose cutout edge 26 defines a pair of opposing projections 28 that form a passage 56 between the opposing projections 28. As the aligner 16 is installed onto the dental arch 14, the attachment body 44 (not visible in FIGS. 25 to 27) passes through the passage 56 as the pair of projections 28 pass through the slot 54 defined by the base 46 and the wing 52. While in the exemplary embodiment of FIG. 25 the projections 28 forming the passage 56 are mirror images of each other, in general each projection 28 may have any suitable shape and size.

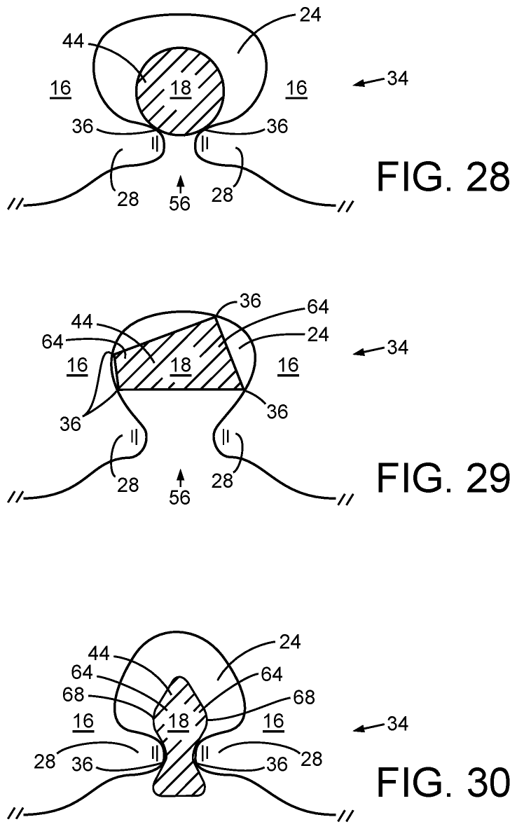

Referring to FIG. 28, the top view of the attachment body 44 (i.e. the attachment 18 with its base 46 and wing 52 removed for clarity) reveals a pair of contact points 36 between the attachment body 44 and each projection 28 when the aligner is in its fully installed position 34, and the tip of the two projections 28 are at the lingual side of the attachment body 44, referring to FIGS. 25 to 27 the projection 28 and the attachment 18 are dimensioned to resiliently engage with each other to hinder displacement of the aligner 16 from its fully installed position.

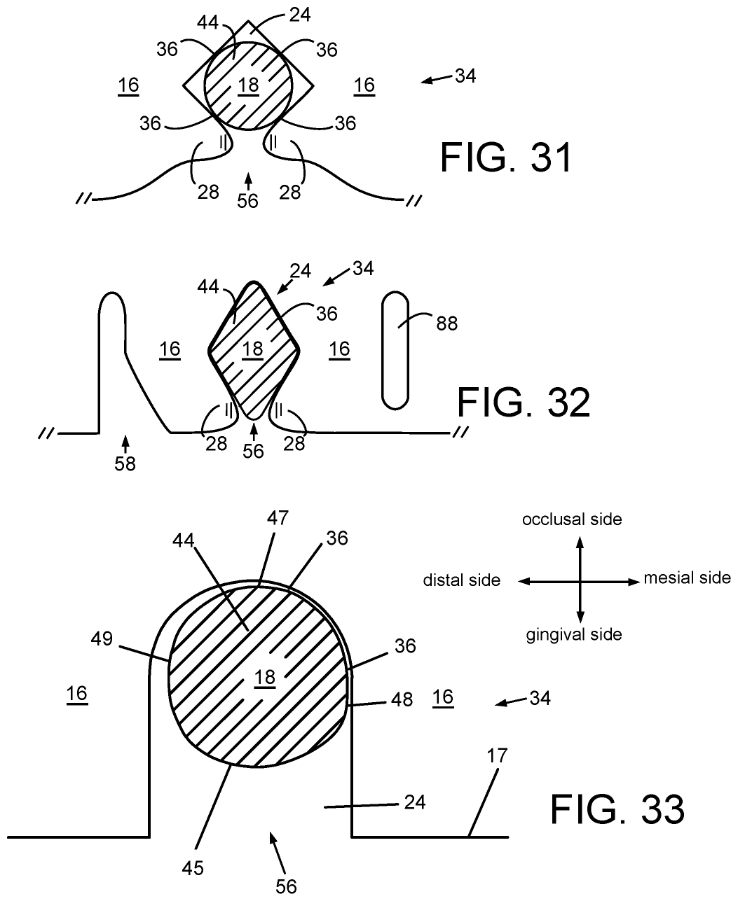

Referring to FIGS. 29 to 31, the attachment body 44 has a cross-sectional shape that may be any suitable shape, and the cutout 24 may have any suitable shape. Examples of various shapes for the attachment body 44 and cutout 24 are shown in FIGS. 29 to 31, including the diamond-shaped cutout 24 of FIG. 31. Referring to FIG. 30, part of the attachment body 44 may extend out of the cutout 24. In this situation the projection 28 is at the gingival side of part of the attachment body 44, and the projection 28 is at the gingival side of the attachment body protrusion 64.

Referring to FIG. 32, the attachment body 44 in some embodiments has a cross-sectional shape that is diamond-shaped. The diamond-shaped cutout 24 that conforms to the diamond-shaped attachment body 44 advantageously provides a strong retention force.

Referring to FIGS. 32, the aligner 16 in some embodiments includes one or more secondary cutout(s) 58 or window(s) 88 that are dimensioned to not engage with any attachment 18 when the aligner 16 is in its fully installed position 34. The secondary cutout(s) 58 increase the flexibility of the aligner 16 material, thereby decreasing the retention force required to move the projection 28 past the attachment 18, and thus makes intentional installation and removal of the aligner 16 easier while advantageously causing no minor displacement of the aligner 16.

Referring to FIGS. 25 to 32, the aligner 16 comprises two projections 28, each one of the projections 28 extending toward the interior of the cutout 24. A part of the each one of the projections 28 is at the gingival side of at least part of the attachment body 44 and contacts the attachment body 44 when the aligner 16 is in its fully installed position 34. The part of the projection 28 and the attachment body 44 being dimensioned to resiliently engage with each other to hinder displacement of the aligner 16 from its fully installed position 34. The features shown in these figures may be applied in any embodiment having the innovative cutout and attachment.

FIGS. 33 to 35 illustrate embodiments where no aligner projection 28 is provided at the gingival side of the attachment body 44 when the aligner is fully installed 34. In these embodiments other ways are employed to inhibit the aligner displacement from fully installed position. A part of the aligner 16 next to the cutout 24 has force engagement with a side surface of the attachment body 44 when the aligner 16 is fully installed. The engagement force is an orthodontic force which can be used to move teeth. This contacting part of the aligner is not at the gingival side of the attachment body 44. The side surface of the attachment body 44 is dimensioned to inhibit this part of the aligner 16 from sliding on a top surface of the attachment body 44. All the features shown in FIGS. 12 to 24 and FIGS. 38 to 41 may also applied to the embodiments shown in FIGS. 33 to 35. By applying the features shown in FIGS. 12 to 24 and FIGS. 38 to 41, a side surface 60 of an attachment body 44 may be dimensioned to inhibit a part of an aligner 16 from sliding on a top surface 62 of the attachment body in the embodiments shown in FIGS. 33 to 35. In these embodiments at least part of the aligner next to the cutout may be spaced away from the tooth surface such that an aligner bulge 105 over an unoccupied space feature 100 is formed next to the cutout 24. This arrangement can make this part of the aligner more flexible and generate more gentle orthodontic force. Intermaxillary elastic or intramaxillary elastic may be applied with the attachment to get a better orthodontic result. In these embodiments an inner surface 90 of the aligner 16 may be engaged with the attachment body 44 when the aligner is fully installed 34. In these embodiments, an outer surface 92 of the aligner may be engaged with the attachment body 44 when the aligner 16 is fully installed 34. In these embodiments, an edge of the cutout 24 may be engaged with the attachment body 44 when the aligner is fully installed 34. In these embodiments a part of the aligner 16 may have force engagement with the attachment body 44 at an occlusal side surface 47, or a mesial side surface 48, or a distal side surface 49 of the attachment body 44 when the aligner 16 is fully installed 34. The part of the aligner 16 may have force engagement with more than one side surfaces of the attachment body 44.

A side surface of the attachment body 44 comprises an occlusal side surface 47, a mesial side surface 48, a distal side surface 49, and a gingival side surface 45. Referring to FIG. 33, part of the aligner 16 has force engagement with an occlusal side surface 47 of the attachment body 44 when the aligner 16 is fully installed 34, and the aligner 16 has at least one contact point 36 with the occlusal side surface 47 and the mesial side surface 48 of the attachment body 44. This arrangement may cause the tooth a torquing movement.

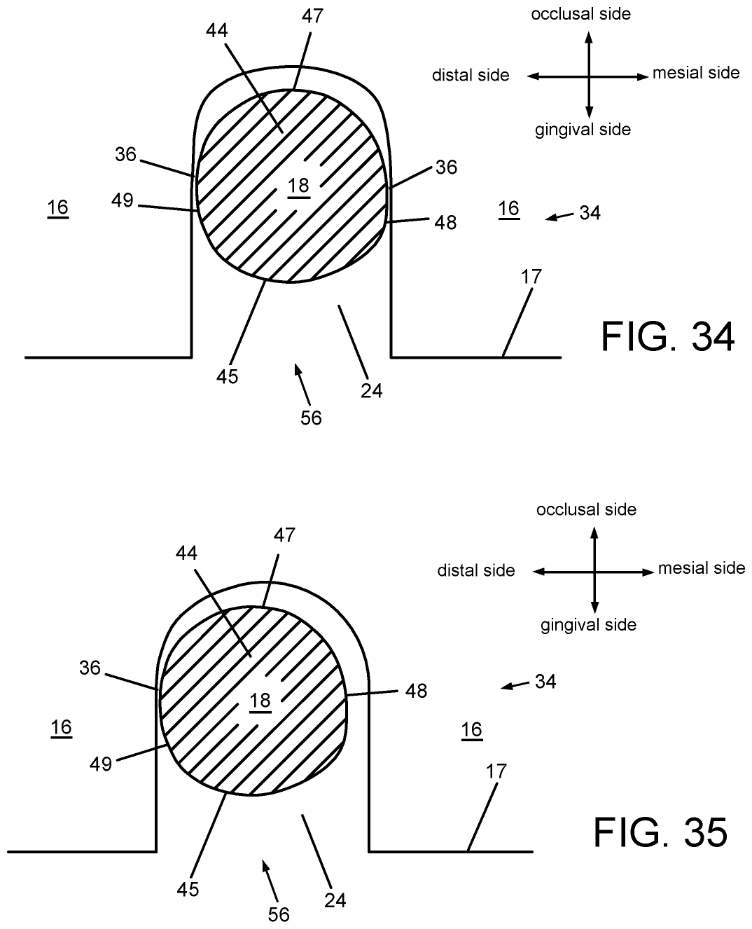

Referring to FIG. 34, part of the aligner 16 has force engagement with a mesial side surface 48 of the attachment body 44 when the aligner 16 is fully installed 34, and the aligner 16 has at least one contact point 36 with the mesial side surface 48 of the attachment body 44. This arrangement may cause tooth to move distally.

Referring to FIG. 35, part of the aligner 16 has force engagement with a distal side surface 49 of the attachment body 44 when the aligner 16 is fully installed 34, and the aligner 16 has at least one contact point 36 with the distal side surface 49 of the attachment body 44. This arrangement may cause tooth to move mesially.

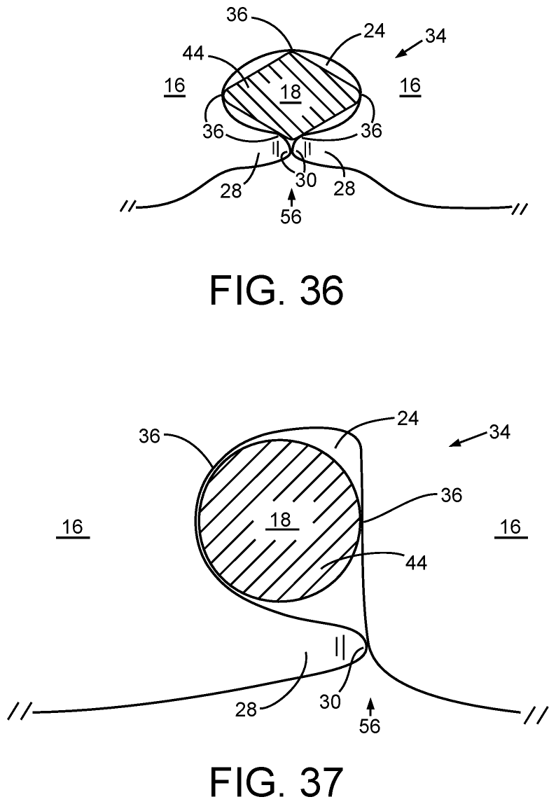

Referring to FIG. 36, in some embodiments the projection tip 30 extends to contact the other projection tip 30 at the opposite side of the passage 56, and the passage 56 is opened by the attachment body 44 during the insertion and removal of the aligner 16. The passage 56 is opened as the attachment body 44 passes through the passage 56 and separates the contact between the opposing projection tips 30 by squeezing the respective projections 28. After insertion or removal of the aligner 16, the respective projections 28 relax to re-close the passage 56 and resume contact between the respective projection tips 30 at the passage 56.

Referring to FIG. 37, in some embodiments the projection tip 30 extends to contact a different portion of the aligner 16 at the other side of the passage 56, and the passage 56 is opened by the attachment body 44 during the insertion and removal of the aligner 16. The passage 56 is opened as the attachment body 44 passes through the passage 56 and compresses the projection 28 to separate the contact between the projection tip 30 and the other portion of the aligner 16. After insertion or removal of the aligner 16, the projection 28 relaxes to re-close the passage 56 and resume contact between the projection tip 30 and the other portion of the aligner 16.

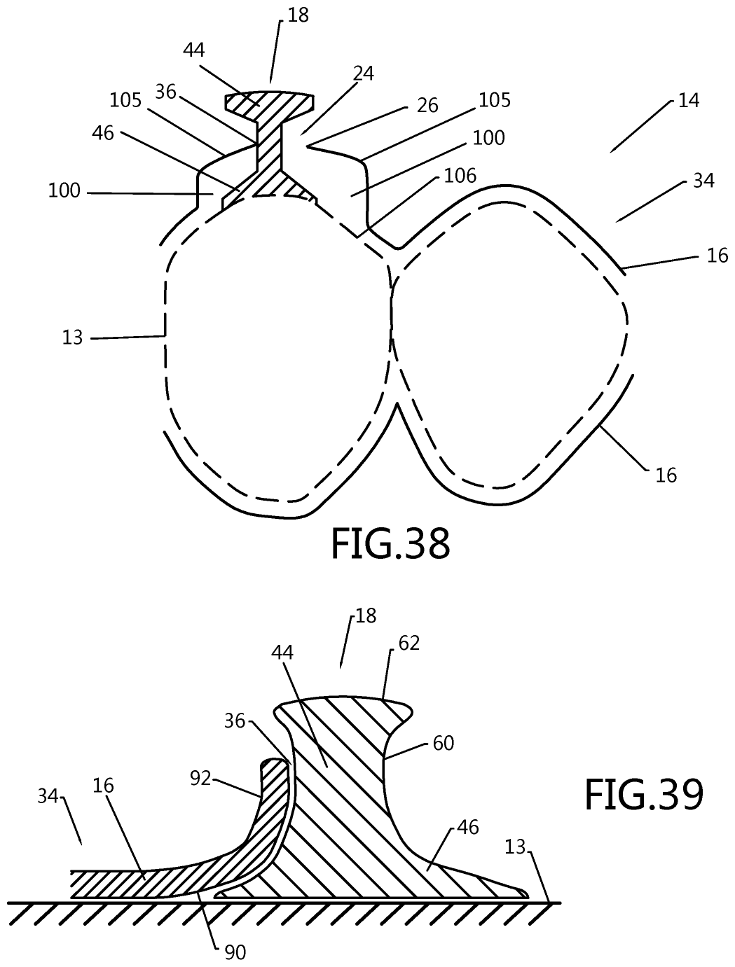

FIG. 38 is a side sectional view of part of a dental arch 14 with an aligner 16 fully installed 34 on it, showing that a part of the aligner 16 next to a cutout 24 of the aligner 16 is engaged with an attachment 18, and an aligner bulge 105 over an unoccupied space feature 100 is formed next to the cutout 24. The attachment 18 has a base 46 and a body 44. The aligner 16 is in its fully installed position 34. The cutout 24 of the aligner 16 has an opening at the gingival edge of the aligner 16. The aligner 16 next to the cutout 24 is spaced away from the tooth surface 13, such that an aligner bulge 105 over an unoccupied space feature 100 is formed next to the cutout 24. The cutout edge 26 is in force engagement with the attachment body 44. This unoccupied space feature 100 under the aligner bulge 105 can increase the flexibility of the aligner 16 and make the engagement force between the cutout edge 26 and the attachment body 44 more gentle and long lasting. This force is an optimal orthodontic force.

This innovation of having an aligner bulge 105 over an unoccupied space feature 100 is applied together with the other innovation features of the attachment 18 and the cutout 24 in this embodiment. The unoccupied space feature 100 is defined by the aligner 16 and one of the tooth surfaces 13 and the attachment base 46. The unoccupied space feature 100 has a definitive shape and has an unoccupied volume of space. The feature of having an aligner bulge over an unoccupied space feature next to a cutout may be applied in any embodiments having the innovative cutout and the attachment.

The engagement force between the cutout edge 26 and the attachment body 44 may be influenced by the unoccupied space feature 100 under the aligner bulge 105. Usually, the engagement may cause the aligner 16 to deform, and the deformation of the aligner 16 may generate an orthodontic force. The aligner 16 delivers an orthodontic force to the tooth by the engagement between the cutout edge 26 and the attachment body 44. An unoccupied space feature 100 under the aligner bulge 105 makes the aligner 16 above the unoccupied space feature 100 more flexible. The orthodontic force generated by the aligner's deformation become more gentle and long lasting, which provides an optimal orthodontic force.

FIGS. 39 to 41 are side sectional views of the portion shown in FIGS. 12 to 18, showing a part of an aligner 16 around an attachment 18 and showing the engagement between the part of the aligner 16 and the attachment body 44 when the aligner 16 is in its fully installed position 34, and showing the part of the aligner 16 at the gingival side of the attachment body 44 contacts the attachment body 44 at a contact point 36. All the features shown in these figures may be applied in any embodiment mentioned above and still encompass the advantages of the cutout and the attachment. By applying the features shown in these figures, a side surface 60 of an attachment body 44 is dimensioned to inhibit a part of an aligner 16 next to the cutout from sliding on a top surface 62 of the attachment body 44.

Referring to FIG. 39, the inner surface 90 of the aligner 16 engages with the attachment body 44 when the aligner 16 is in fully installed position 34. The aligner inner surface 90 has at least one contact point 36 with the side surface 60 of the attachment body 44.

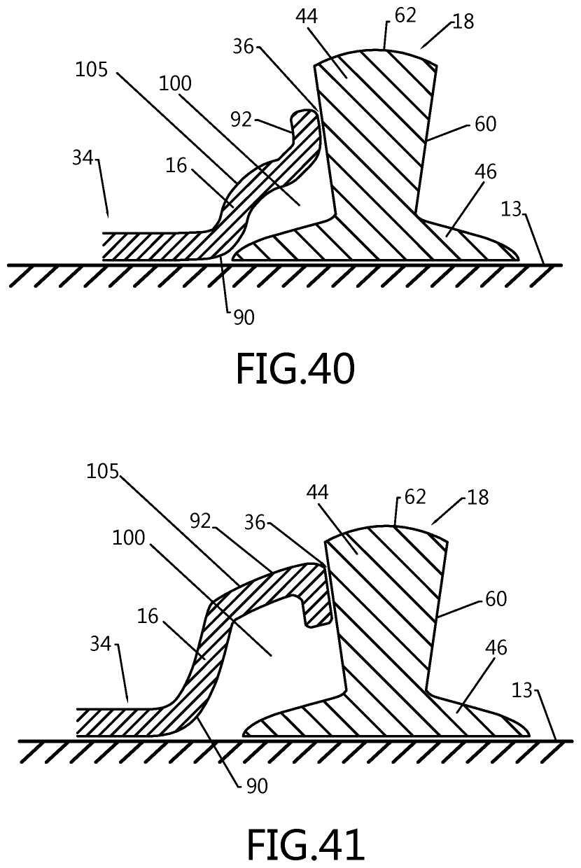

Referring to FIG. 40, the inner surface 90 of the aligner 16 engages with the attachment body 44 when the aligner 16 is in fully installed position 34. The aligner inner surface 90 has at least one contact point 36 with the side surface 60 of the attachment body 44. An aligner bulge 105 over an unoccupied space feature 100 is formed next to the attachment body 44. Indeed, the aligner bulge 105 is also next to the cutout 24 because the attachment body 44 is in the cutout 24.

Referring to FIG. 41, the outer surface 92 of the aligner 16 engages with the attachment body 44 when the aligner 16 is in fully installed position 34. The aligner outer surface 92 has at least one contact point 36 with the side surface 60 of the attachment body 44. An aligner bulge 105 over an unoccupied space feature 100 is formed next to the attachment body 44. The aligner bulge is also next to the cutout 24 because the attachment body 44 is in the cutout 24.

The attachments mentioned in these embodiments are dimensioned for use with one or more aligners during the treatment.

FIGS. 12 to 18 show different attachment body designs and shows ways of engagement between the attachment body and the part of the aligner at the contact point when the aligner is in its fully installed position, and the features shown in these figures can be applied in any embodiments having the cutout and the attachment. The way of contact engagement showed in these Figures may also be applied to any contact engagement between an attachment and a part of an aligner which is not at the gingival side of the attachment.

FIGS. 21 to 24 are four variations of the attachment, whereby these variations may be applied in any embodiments mentioned herein having the cutout and the attachment. These figures of side sectional view of the attachment show different attachment design and different ways of engagement between the attachment body 44 and a part of an aligner 16 at the contact point 36 when the aligner is in fully installed position, and the part of the aligner 16 is at the gingival side of the attachment body 44 when the aligner is fully installed. These attachments and these ways of engagement between the part of the aligner and the attachment may be applied in any embodiments about the innovative attachment and the cutout. The way of contact engagement showed in these figures may also be applied to any contact engagement between an attachment and a part of an aligner which is not at the gingival side of the attachment.

All the figures in a side sectional view of the embodiments show different features with all the Figures in a top view of the embodiments, such that all the features shown in the figures of a side sectional view may be applied together with all the features shown in the figures of a top view to form an embodiment having the cutout and attachment.

The aligner cutouts mentioned in this application can be manufactured by automatic cutting machine or razer cutting machine using general known methods and technique.

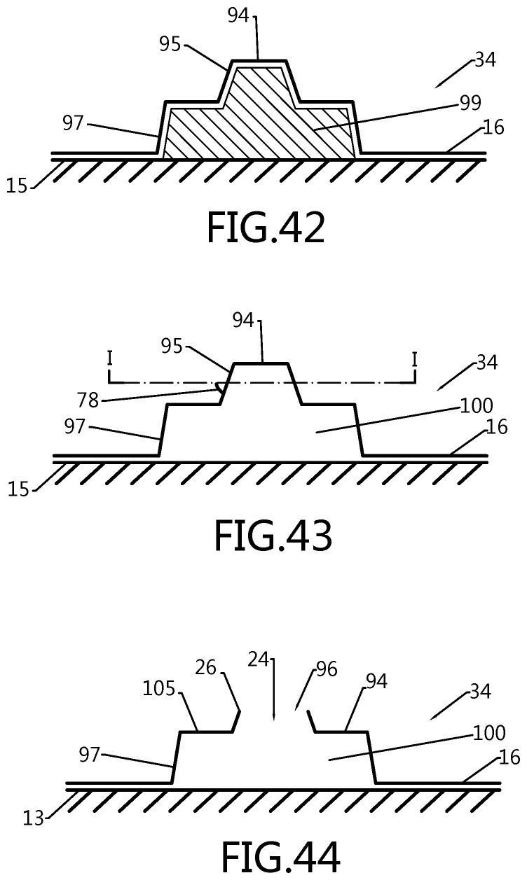

FIGS. 42 to 53 illustrate a new method of manufacturing an orthodontic appliance for repositioning teeth, the cutouts mentioned in this application can be made with higher accuracy by using this new method. The orthodontic appliance comprising at least one aligner 16 having at least one cutout 24 which has an opening at a gingival edge of the aligner 16 when the aligner 16 is fully installed.

The method comprises the following steps:
(a) referring to FIG. 42, providing a positive model of a dentition having at least one added structure 99 on a tooth surface 15 of the model;
(b) referring to FIG. 42, forming the aligner 16 over the positive model and over the added structure 99 such that the aligner 16 includes an aligner protrusion 94 at the added structure location; and
(c) referring to FIG. 43, cutting across the aligner protrusion 94 along lines I-I by an automatic cutting machine to form a cutout 24 of the aligner 16 having a cutout edge 26 raising away from a tooth surface 15 of the model.

The added structure is a non-dental structure, i.e. it does not form part of the patient's initial or final tooth arrangement in the dentition model. Instead the added structure is designed to provide a sacrificial protrusion for subsequent cutting steps.

Dentition modelling may use common knowledge in the field of orthodontics to obtain a digital model of a dentition of a patient using a digital scanner, such as iTero. After the repositioning treatment has been design, a plurality of modified digital dentition models can be defined having a plurality of tooth arrangements. One of the modified digital dentition models and a digital model of an added structure can be merged into a combined digital model. A positive model of the combined digital model can be printed out by a 3D printing machine using existing techniques and materials. Similarly, method to program the aligner tooth arrangements by computer are well known. The auto edge-cutting machine for aligner may be a CNC laser or cutting machine. The edge cutting machine may cut the edge for the aligner and cut the aligner protrusion to form a cutout.

In this embodiment, the added structure 99 is applied at the location the cutout 24 is desired, and the aligner protrusion 94 is formed over the added structure 99. The aligner protrusion 94 provides a cross-section along the cross-section line I-I and this cross-section forms the desired cutout 24.

In some embodiments, the added structure extends vertically to a gingival side of the model of the dentition, so that the cutout has an opening toward the gingival side of the aligner, i.e. towards the gingiva of the teeth when the aligner is fully installed. The opening of the cutout toward the gingiva is made by the automatic cutting machine, which cuts laterally across the aligner protrusion 94 and cuts across the aligner 16 along its gingival margin to form the aligner edge.

Referring to FIG. 43 the aligner protrusion 94 may have at least one sidewall 95 extending at an angle of more than 60 degrees relative to the model tooth surface 15 (i.e., the surface plane at the location of the protrusion) when the aligner is fully seated on the model. The cross-section line His parallel to the model tooth surface 15, the angle 78 between the aligner protrusion sidewall 95 and the cross-section line I-I is more than 60 degrees, such that the sidewall 95 extends at an angle of more than 60 degrees relative to the model tooth surface 15.

Referring to FIG. 43, in an improved embodiment the aligner protrusion 94 has a base 97 which extends laterally beyond a distal part of the protrusion. That is, the base of the protrusion is wider than its distal portion. By cutting across the distal part of the aligner protrusion 94, (referring to FIG. 44) an aligner bulge over an unoccupied space feature 100 is formed next to the cutout 24 when the aligner 16 is in its fully installed position 34.

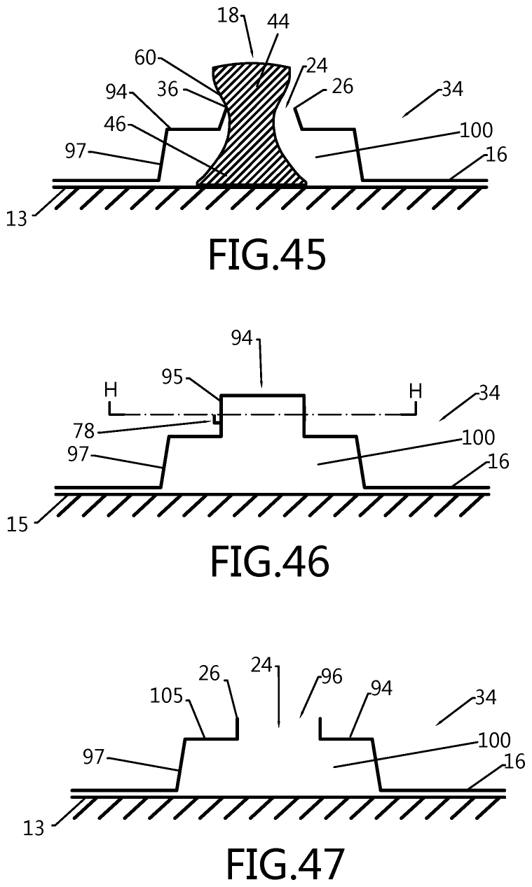

Referring to FIG. 45, the method may comprise cementing an attachment 18 to the tooth surface 13 and installing the aligner onto the teeth by resiliently engaging the attachment 18 with a part of the aligner 16 next to the cutout 24 to hinder displacement of the aligner 16 from its fully installed position.

FIGS. 46 and 47 shows an improved embodiment, the aligner protrusion 94 having two sidewalls 95 extending substantially orthogonal to the model teeth surface 15 at the location of the protrusion 94 when the aligner is seated on the model. Referring to FIG. 46, the cross-section line H-H is parallel to the model tooth surface 15, the angle 78 between the aligner protrusion sidewall 95 and the cross-section line is 90 degrees, such that the sidewall 95 extends at an angle of 90 degrees relative to the tooth surface 13.

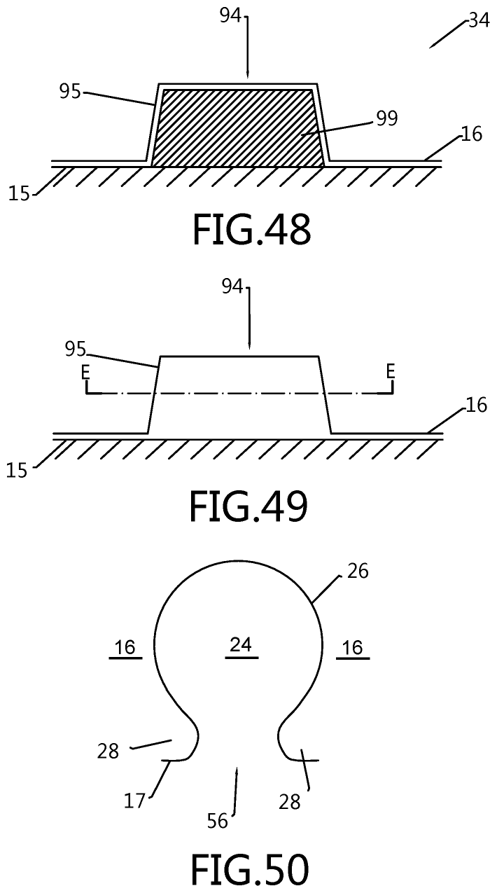

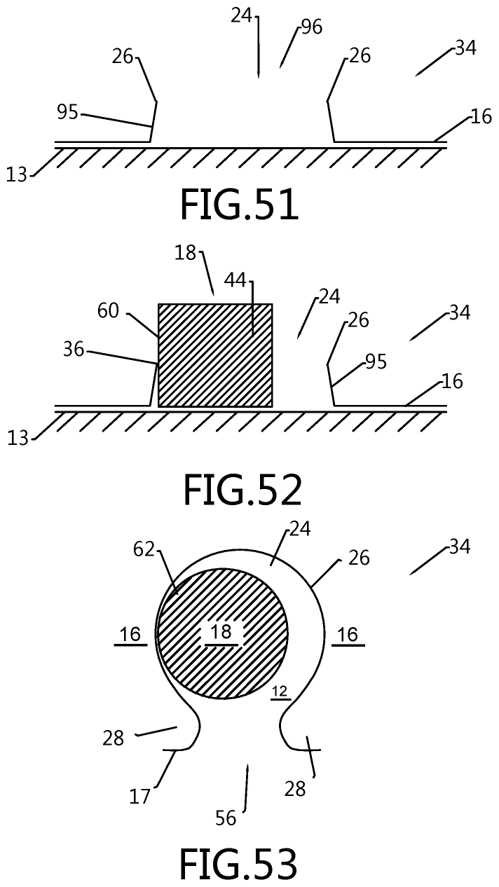

FIGS. 48 to 53 shows another improved embodiment. FIG. 48 is a side sectional view showing an aligner protrusion 94 formed on an added structure 99 on a model tooth surface 15, the aligner protrusion 94 has a sidewall 95 which extends at an angle greater than 60 degrees relative to the model tooth surface 15 when the aligner is fully installed 34 on the model teeth 15. FIG. 49 is a side sectional view showing a cross section of the aligner protrusion 94 made along lines E-E when the aligner 16 is fully installed 34 on the model teeth 15. This cross section forms a cutout 24 of the aligner 16. FIG. 50 is a top view of the cross section along lines E-E of the aligner protrusion 94 showing a cutout edge 26 of the cutout 24 and a gingival edge 17 of the aligner 16. The cutout 24 has an opening and passage 56 toward gingival side. The cutout edge 26 defines a pair of opposing projections 28 that forms the passage 56 between the opposing projections 28. The cutout edge 26 and the gingival edge 17 of the aligner 16 are made by automatic cutting machine. FIG. 51 is a side sectional view showing the cutout 24 and cutout edge 26 when the aligner is fully installed 34 on the teeth surface 13. FIG. 52 is a side sectional view showing an attachment 18 is cemented on the tooth surface 13 in the cutout 24 of the aligner 16 when the aligner 16 is fully installed 34, and a side surface 60 of the attachment body 44 has a contact point 36 with the cutout edge 26. FIG. 53 is a top view of the cutout 24 and the attachment 18, showing the attachment 18 is cemented on the tooth 12 in the cutout 24 and a passage 56 is formed by a pair of opposing projections 28 of the aligner 16 when the aligner 16 is fully installed 34. The cutout 24 can be any forms showed in this application; the attachment 18 can be any forms showed in this application; the contact point 36 between the side surface 60 of the attachment 18 and the cutout edge 26 can be anywhere along the cutout edge 26 and can be more than one contact points. The projection 28 and the attachment 18 are dimensioned to hinder displacement of the aligner 16 from its fully installed position 34.

The aligner manufacturing is formed on model tooth surface 15. After manufacturing, the aligner is installed on the tooth surface 13.

All cutting machines have positioning tolerances, so the cutout location will vary from expected when cutting orthogonally into the side of the aligner. By precisely defining the cutout location with the protrusion and then cutting laterally through the protrusion, the manufacturing tolerance only affects the standoff distance to the aligner surface. When the sidewall 95 of the protrusion is very steep, e.g. extending at an angle more than 60° relative to the tooth surface, preferably substantially 90°, production accuracy is greatly improved.

### REFERENCE SIGNS LIST

Orthodontic appliance 10
Teeth 12
Tooth surface 13
Dental arch 14
Model tooth surface 15
Aligner 16
Aligner gingival edge 17
Attachment 18
Ridge 20
Indentation 22
Cutout 24
Cutout edge 26
Projection 28
Projection tip 30
Insertion route 32
Fully installed position 34
Contact point 36
Displaced position 38
Inner edge 40
Attachment body 44
Gingival side surface 45
Base 46
Occlusal side surface 47
Mesial side surface 48
Distal side surface 49
Bevel 50
Wing 52
Slot 54
Passage 56
Secondary cutout 58
Side surface of attachment body 60
Top surface of attachment body 62
Attachment body protrusion 64
Attachment body protrusion tip 68
Compressive force 72
Vertical component force 74
Horizontal component force 76
Angle 78
Window 88
Aligner inner surface 90
Aligner outer surface 92
Aligner protrusion 94
Aligner protrusion sidewall 95
Cross section 96
Aligner protrusion base 97
Added structure 99
Unoccupied space feature 100
Aligner bulge 105
Tooth Side surface 106

1-15. (canceled)

16. An orthodontic appliance for repositioning teeth, the appliance comprising:
an aligner having cavities dimensioned to receive teeth, and the aligner having a thickness and comprising a cutout for being located at a tooth surface of a tooth of the teeth when the aligner is fully installed, and the cutout having an opening at a gingival edge of the aligner;
an attachment dimensioned for being attached to the tooth surface where the cutout is aligned, the attachment having an attachment body and a base, the base being connected to the tooth surface, the attachment body projecting away from the tooth surface, wherein a height of the attachment body is at least 1.8 times greater than the thickness of the aligner at a cutout edge of the cutout; and
wherein a part of the aligner is at the gingival side of the attachment body and contacts the attachment body when the aligner is in its fully installed position, a side surface of the attachment body is dimensioned to inhibit the aligner from sliding on a top surface of the attachment body, the part of the aligner and the attachment body are dimensioned to resiliently engage with each other to hinder displacement of the aligner from its fully installed position.

17. The orthodontic appliance of claim 16 wherein the attachment comprises a wing separated from the base, and the wing is dimensioned to prevent the aligner from sliding on the top surface of the attachment body.

18. The orthodontic appliance of claim 16 wherein at least part of the side surface of the attachment body forms one of an acute and a right angle with the tooth surface.

19. The orthodontic appliance of claim 16 wherein the aligner next to the cutout is spaced away from the tooth surface such that an aligner bulge over an unoccupied space feature is applied next to the cutout when the aligner is fully installed.

20. The orthodontic appliance of claim 16 wherein an inner surface of the aligner is engaged with the attachment body when the aligner is fully installed.

21. The orthodontic appliance of claim 16 wherein an edge of the cutout is engaged with the attachment body when the aligner is fully installed.

22. An orthodontic appliance for repositioning teeth, the appliance comprising:
an aligner having cavities dimensioned to receive teeth, and the aligner having a thickness and comprising a cutout for being located at a tooth surface of a tooth of the teeth when the aligner is fully installed, and the cutout having an opening at a gingival edge of the aligner;
an attachment dimensioned for being attached to the tooth surface where the cutout is aligned, the attachment having an attachment body and a base, the base being connected to the tooth surface, the attachment body projecting away from the tooth surface, wherein a height of the attachment body is at least 1.8 times greater than the thickness of the aligner at a cutout edge of the cutout; and
wherein a part of the aligner next to the cutout has contact with a side surface of the attachment body when the aligner is fully installed, and wherein the side surface of the attachment body is dimensioned to inhibit the aligner from sliding on a top surface of the attachment body.

23. The orthodontic appliance of claim 22 wherein the attachment comprises a wing separated from the base, and the wing is dimensioned to prevent the aligner from sliding on the top surface of the attachment body.

24. The orthodontic appliance of claim 22 wherein at least part of the side surface of the attachment body forms one of an acute and a right angle with the tooth surface.

25. The orthodontic appliance of claim 22 wherein the part of the aligner next to the cutout has force engagement with the side surface of the attachment body when the aligner is fully installed.

26. The orthodontic appliance of claim 22 wherein the aligner next to the cutout is spaced away from the tooth surface such that an aligner bulge over an unoccupied space feature is applied next to the cutout when the aligner is fully installed.

27. The orthodontic appliance of claim 22 wherein an inner surface of the aligner is engaged with the attachment body when the aligner is fully installed.

28. The orthodontic appliance of claim 22 wherein an edge of the cutout is engaged with the attachment body when the aligner is fully installed.
